(19) United States
(12) Patent Application Publication
(10) Pub. No.: US 2002/0034942 A1
(43) Pub. Date: Mar. 21, 2002

(54) Probabilistic reasoning mobile agent system for network testing

(76) Inventors: Laila Khreisat, Flanders, NJ (US); Tarek N. Saadawi, Teaneck, NJ (US)

Correspondence Address: Frank Chau, Esq., F. CHAU & ASSOCIATES, LLP, Suite 501, 1900 Hempstead Turnpike, East Meadow, NY, 11554, US

(21) Appl. No.: 09/825,577

(22) Filed: Apr. 3, 2001

Related U.S. Application Data
(60) Provisional application No. 60/194,313, filed on Apr. 3, 2000.

(51) Int. Cl. H04Q 7/20

(52) U.S. Cl. 455/423; 455/424; 455/425

(57) ABSTRACT

The present invention provides an intelligent mobile agent system for testing telecommunications networks. The system is a general purpose method that can be used for any type of network testing, including vulnerability assessment and intrusion detection. The system consists of mobile agents equipped with tests to be performed on targets in a network. The tests and the targets are selected using probabilistic reasoning in a manner that maximizes the probability of selection. The system detects a problematic node, and selects the most vulnerable nodes within the neighborhood of the selected node and applies the appropriate set of tests to them. The system selects tests and targets in an optimum manner that ensures detection of any problems within the network in a timely and efficient manner, without overloading the network.

### GOVERNMENT LICENSE RIGHTS

The U.S. Government has a paid-up license in this invention under Contract No. DAAL01-96-2-002 with the U.S. Army Research Library.

### BACKGROUND OF THE INVENTION

1. Field of the Invention

The present invention relates to network testing, and particularly to a probabilistic reasoning mobile agent system for testing telecommunication networks.

2. Description of the Related Art

Telecommunication networks undergo continuous testing such as trouble shooting, fault isolation, vulnerability assessment, and intrusion detection, to ensure the proper operation of the network. Conventional testing schemes can sometimes overload the network, with increased bandwidth and resource usage. Networks have a dynamic nature, where the state of the network undergoes constant change, and the available set of tests to perform can be too large to be applied to the network simultaneously.

Mobile agent technology has been used in dealing with problems in networks, such as increased bandwidth requirement and network management, resulting from the rapid growth of the internet. The technology allows the implementation of more flexible and decentralized network architectures. A mobile agent is a self-contained and identifiable computer program that can move within the network and act on behalf of the user or another entity [10]. Mobile agents can meet provided they are at the same location. They can also communicate with one another even if they are at different locations. The main goals for using mobile agents in general, is the reduction of network traffic and asynchronous interaction [10].

The mobile agent technology models a network of computers, as a collection of multiple agent-“friendly” environments acting as agent servers by offering a service to mobile agents that enter, and the agents are modeled as programmatic entities that move from location to location, performing tasks for users [12]. The mobile agent technology has three major components: an agent programming language, an interpreter, and agent protocols [16]. The agent language is used to program the agents and the places. An interpreter for interpreting the language, and agent protocols that allow interpreters residing on different computers to exchange agents.

The mobile agent systems include applications of intelligent information retrieval, network and mobility management, electronic commerce, and network services. Research has been conducted in the use of intelligent mobile agents in implementing network security. [15] propose an architecture for active defense of computer systems against intrusions by employing autonomous mobile agents. The mobile agents are trained to detect anomalous activity in the system's traffic by being subjected to a training phase. Agents use genetic programming to actually learn to detect anomalous activity. Genetic programming allows for both feedback learning, and human-guided learning and discovery to find new combinations of activities to monitor for [14]. However, agent training takes time and is tailored to one specific system that is being monitored.

Intelligent mobile agents are viewed as sophisticated software entities possessing artificial intelligence that autonomously travel through a network environment and make complex decisions on behalf of the user. Intelligent mobile agents for vulnerability detection has been proposed and implemented by [2,3]. In their scheme, mobile agents are equipped with sets of assessment tests to be applied to nodes within the network to detect vulnerabilities, wherein a modified genetic algorithm was used for test selection.

Probabilistic reasoning methods are also used in implementing network security, however, they suffer from many disadvantages [4,5], such as, the need for complete information, their intractability (need exponential time for execution), and their incompleteness. Further, the conventional reasoning method can only reason with respect to one dimension, meaning that tests are related to the whole network [11]. For example, Tᵢ refers to test number i throughout the whole network.

Hence, it is desirable to provide an improved intelligent mobile agent system for testing telecommunications networks, such as vulnerability assessment, and intrusion detection.

### SUMMARY OF THE INVENTION

The present invention provides an intelligent mobile agent system for testing telecommunications networks.

In one aspect of the present invention, there is provided a system which is a general purpose-testing scheme that can be used for any type of network testing, such as vulnerability assessment, and intrusion detection.

In another aspect of the present invention, there is provided an intelligent mobile agent system that uses probabilistic reasoning for test and target selection. The system considers vulnerabilities and intrusions. When the system detects a problematic node, it selects all nodes within the neighborhood of the selected node and applies the appropriate set of tests to them. The present invention provides a new reasoning method that does not suffer from these problems of the need for complete information, intractability, and incompleteness. The present invention provides an adaptive method where the accuracy of results improve gradually as computation time increases, providing a trade-off between resource consumption and output quality. The method comprises of three strategies, BASIC, INEQS, and EXPSN. Depending on the time and resource limitations and accuracy of results needed, either one of these strategies can be used. BASIC is the most efficient strategy, with wider intervals for the probabilities. INEQS generates tighter intervals than BASIC. EXPSN is the most sophisticated strategy, which compensates for missing information by using a recursive method of substitution. EXPSN is more time and resource consuming than the previous two strategies, however, it gives more accurate results.

The present invention provides a reasoning method to handle two dimensional reasoning, wherein tests are denoted by Tᵢⱼ, which refers to test number i on target number j. Thus in the generalized version test and target selection is done simultaneously.

These and other aspects, features and advantages of the present invention will become apparent from the following detailed description of illustrative embodiments thereof, which is to be read in connection with the accompanying drawings.

### BRIEF DESCRIPTION OF THE DRAWINGS

The above objects and advantages of the present invention will become more apparent by describing in detail embodiments thereof with reference to the attached drawings in which:

FIG. 1 is a diagram of a clustering of network nodes.

FIG. 2 is a flowchart diagram of an advanced two dimensional algorithm.

FIG. 3 is a plot of the probability of selection versus vulnerability for nodes 0, 1, 2 and 3.

FIG. 4 is a plot of the probability of selection versus vulnerability for nodes 4, 5, 6 and 7.

FIG. 5 is a plot of the probability of selection versus vulnerability for nodes 8 and 9.

FIG. 6 is a plot of the probability of selection versus the probability of being positive for tests 0, 1 and 29 for nodes 0 and 1, respectively.

FIG. 7 is a plot of the probability of selection versus the probability of being positive for tests 7 and 29 for nodes 0 and 1, respectively.

FIG. 8 is a plot of the number of times test 1 is being selected as a negative test and number of times test 1 was selected as a positive test for all the nodes.

FIG. 9 is a plot of the number of times test 29 is being selected as a negative test and number of times test 29 was selected as a positive test for all the nodes.

FIG. 10 is a plot of the cumulative total of the number of times tests were selected within 200 stages of execution of the algorithm.

FIG. 11 is a plot of the cumulative total of the number of times tests were selected within 200 stages of execution of the algorithm.

FIG. 13 is a plot of the probability of selection and vulnerability for nodes 4, 6, 2 and 3.

FIG. 14 is a plot of the probability of selection and vulnerability for nodes 1, 5, 0 and 8.

FIG. 15 is a plot of the probability of selection and vulnerability for nodes 7 and 9.

FIG. 16 is a plot of the probability of selection and vulnerability for nodes 4 and 6.

FIG. 17 is a plot of probability of miss for the one dimensional, advanced two dimensional and random cases.

### DESCRIPTION OF EMBODIMENTS

The present invention will be described in terms of illustrative flowcharts and plots. It is to be understood that these flowcharts and plots are described with particular values, such as probability, vulnerability, and nodes, etc. These values are illustrative and should not be construed as limiting the present invention.

I. Introduction

A. Theoretical Basis

The test and target selection in the present invention can be implemented by using of adaptive probabilistic reasoning. The theoretical basis for this method is propositional logic which was introduced in the Artificial Intelligence (AI) community by [6]. The present invention can further be implemented by using of a modified variant of the more general framework presented in [7]. The present invention starts with a propositional language L whose formulas are finitely constructed in the usual way from a denumerable set of primitive propositions (atoms), and logical connectives [symbol] (conjunction), [symbol] (disjunction), and [symbol] (negation) [8]. A probabilistic formula is a statement of the form a₁P(ψ₁)+ . . . +aₖP(ψₖ)≧a, where k is a positive integer, α's are reals, and ψ's are propositional formulas. For example, 2.0*P(T₁ [symbol] T₂)−7.5*P(T₃)≧3.9 is a propositional formula. A probabilistic theory, is a finite set of probabilistic formulas. A semantics for probabilistic formulas is obtained by considering probabilistic interpretations, that is, probability distributions over the set of all possible worlds obtained by assigning truth-values (either true orfalse) to the atoms occurring in the formulas. The probability P(ψ) of a propositional formula ψ in a probabilistic interpretation is the sum of probabilities of the possible worlds in which ψ is true. The probabilistic models of a probabilistic formula are exactly those probabilistic interpretations in which the inequality of the formula holds (that is, true). As usual, a probabilistic theory entails a probabilistic formula if and only if the formula is true in each model of the theory.

Since probabilistic formulas are linear mappings, each probabilistic theory entails a convex hull of consistent probabilities for each propositional formula. In other words, for any probabilistic theory Γ and for any propositional formula ψ, there is a tightest closed interval [a,b] of reals such that Γ entails a≦P(ψ)≦b . Given any Γ and ψ, determining the tightest interval [a,b] is the probabilistic reasoning problem. Since the tightest interval [a,b] gives the exact answer, any wider interval [a′,b′] (where a′≦a≦b≦b′) is considered an approximate answer.

In the present invention, “clause” is used to mean “propositional clause”, “formula” to mean “probabilistic formula”, and “theory” to mean “probabilistic theory.

B. Adaptive Probabilistic Reasoning

The present invention can be implemented by using probabilistic theories consisting of linear weight inequalities over propositional clauses. The theories were introduced in [7]. Any given probabilistic theory is converted into a system of linear inequalities [9] that explicitly represent the constraints among the probabilities of propositional clauses present in the theory. Solutions of this linear programming problem provide the probabilities of any propositional clause posed as a query.

In addition to the propositional theory and the query, the user of this reasoning system is allowed to specify a set of propositional clauses, called the control set; the clauses in the control set are also used in generating the linear inequalities. For adaptive reasoning, the control set, which is initially set to the clauses in the input theory and query, is gradually expanded by adding new clauses to it. The accuracy of the answer increases with the increase in the control set, and the exact answer is guaranteed in the limiting case when the control set contains all propositional clauses.

1) The Strategies

In the present invention, three different strategies are used in generating the linear inequalities. In the first strategy, called BASIC, standard probability axioms are used in generating only equalities over the probabilities of only the clauses in the control set. In the second strategy, called INEQS, clauses that are not in the control set result in the generation of inequalities among the probabilities of the clauses in the control set. In the third strategy, called EXPSN, the clauses missing from the control set are recursively substituted by constraints over clauses in the control set. Note that INEQS and EXPSN generate at least all the constraints that are generated by BASIC.

A very important concept is that of a child of a clause. A conjunctive clause is said to be a child of any maximal proper conjunctive sub-clause. Two children of a clause are said to be compatible if and only if they differ in only one literal, which occurs positively in one and negatively in the other. The children relation is also extended to the descendant relation in the usual way. For example, T₁ [symbol] T₂,T₁ [symbol] T₃ are both children of T₁, and T₁ [symbol] T₂ and T₁ [symbol] [symbol] T₂ are compatible children of T₁.

a). Strategy BASIC

In strategy BASIC, three kinds of linear equalities are generated from the clauses in the control set D:

i) For each disjunctive clause ψ=T₁ [symbol] . . . [symbol] Tₘ (m>1) such that D contains ψ, each non-conjunctive descendant of ψ, and T₁ [symbol] . . . [symbol] Tₘ, the following linear equality is generated:

P(ψ)=Σ{P(φ)|φ is a child of ψ}−Σ{P(φ)|φ is a grandchild of ψ}+ . . . +(−1)^{m+1}P(T₁ [symbol] . . . [symbol] Tₘ)

ii) For each conjunctive clause ψ=T₁ [symbol] . . . [symbol] Tₘ (m>1) such that D contains ψ, each non-disjunctive ancestor of ψ, and T₁ [symbol] . . . [symbol] Tₘ, the following linear equality is generated:

$$P ( {T}_{1} ⋁ … ⋁ {T}_{m} ) = {\sum }_{i = 1}^{m} P ( {T}_{i} ) - \sum \{ P ( ϕ ) \vert ϕ$$

is a non-disjunctive ancestor of ψ}

+ . . . +(−1)^{m+1}P(T₁ [symbol] . . . [symbol] Tₘ).

iii) For each non-disjunctive clause ψ and its compatible children φ and φ′ in D, the following linear equality is generated:

P(ψ)=P(φ)+P(φ′)

b) Strategy INEQS

Strategy INEQS extends the BASIC strategy in the sense that if some descendant of a clause is missing from the control set, then instead of discarding the linear equality altogether, a linear inequality is generated. For a disjunctive clause ψ, T₁ [symbol] . . . [symbol] Tₘ (m>1) such that D contains ψ, and some of ψ's descendants, a ≧ inequality is generated if the probability of the missing descendant(s) was to be added if it was in the control set D. Otherwise, a ≦ inequality is generated. For atomic and conjunctive clauses a ≧ inequality is generated if a child is missing.

c) Strategy EXPSN

EXPSN is the most sophisticated of the three strategies, because it expands missing clauses whenever possible. Again it is based on the BASIC strategy, but if some descendant ψᵢ (direct or not) of a clause ψ is missing, it tries to replace it by its expansion, meaning, it tries to generate the linear equality corresponding to the ψᵢ and replace ψᵢ by its expansion in the original linear equality that is being constructed. The expansion procedure is recursive in the sense that if one or more of ψᵢ's descendants are missing, then EXPSN tries to expand these clauses too. If a clause cannot be expanded (because some of its descendants are missing, and cannot be expanded), then the linear equality is not generated. An important restriction on EXPSN is that, when trying to expand a disjunctive clause of size m, and its conjunctive descendant ψₘ of size m is missing, EXPSN does not try to expand ψₘ as this would result in an infinite loop.

In all three strategies the basic constraints between probabilities of clauses have to hold. For a two literal case, these constraints are:

P(T₁ [symbol] T₂)≧{P(T₁),P(T₂)}, P(T₁)≧P(T₁ [symbol] T₂), P(T₂)≧P(T₁ [symbol] T₂).

In other words, the probability of a child clause is always less than or equal to the probability of the parent clause, this extends to the descendant relation in the usual way.

Let Z denote the probabilistic theory, C the control set and Q the query.

The following examples illustrate cases where we have complete information and the cases of missing information to show what linear inequalities are generated by the three strategies.

The present invention starts with a probabilistic theory Z₁ where some information is missing.

Z₁:P(T₁)=0.02, P(T₂)=0.01.

Suppose the system is asked to determine the probability of the query Q₁=T₁ [symbol] T₂. The initial control set (C₁) consists of only the clauses present in the theory and the query, thus C₁ consists of {T₁, T₂, T₁ [symbol] T₂}.

BASIC will not generate any equalities since the clause T₁ [symbol] T₂ is missing. The same is true for EXPSN, since there are no clauses in the control set that can be used to substitute for the missing clause. So both BASIC and EXPSN provide the answer [0.02,1], this answer comes from the fact that P(T₁ [symbol] T₂)≧P(T₁), and P(T₁ [symbol] T₂)≧P(T₂).

As for INEQS, the following inequality is generated P(T₁ [symbol] T₂)≦P(T₁)+P(T₂), and

the answer is a tighter interval [0.02,0.03].

For the control set C₁′ obtained by adding T₁ [symbol] T₂ to C₁, all three strategies generate the following equality: P(T₁ [symbol] T₂)=P(T₁)+P(T₂)−P(T₁ [symbol] T₂), and give the answer [0.02,0.03].

If the two clauses T₁ [symbol] [symbol] T₂, and [symbol] T₁ [symbol] T₂ are added to C₁′, which now consists of {T₁, T₂, T₁ [symbol] T₂, T₁ [symbol] [symbol] T₂, [symbol] T₁ [symbol] T₂, T₁ [symbol] T₂}, then BASIC generates the following equalities:

P(T₁ [symbol] T₂)=P(T₁)+P(T₂)−P(T₁ [symbol] T₂)

P(T₁)=P(T₁ [symbol] T₂)+P(T₁ [symbol] [symbol] T₂)

P(T₂)=P(T₁ [symbol] T₂)+P( [symbol] T₁ [symbol] T₂)

And this is the case of complete information, no clause is missing from the control set.¹

If the control set consists of the following clauses: T₁, T₁ [symbol] T₂, [symbol] T₁ [symbol] T₂, T₁ [symbol] T₂, then the inequalities/equalities generated are:

EXPSN: P(T₁ [symbol] T₂)=P(T₁)+(P(T₁ [symbol] T₂)+P( [symbol] T₁ [symbol] T₂))−P(T₁ [symbol] T₂)

INEQS: P(T₁)≧P(T₁ [symbol] T₂), P(T₁ [symbol] T₂)≧P(T₁)−P(T₁ [symbol] T₂)

BASIC: does not generate any equalities.

The method of reasoning runs in a time that is polynomial in the size of the control set D [5]. After the constraints (equalities/inequalities) have been generated that capture the probabilistic dependencies among the clauses in the control set, they are combined with those in Z to form a linear programming problem, which is then solved to provide probabilities of arbitrary clauses. Solving a linear programming problem in known to be O(m^{3.5}E²) [9], where m is the size of the control set (which is equivalent to the number of variables in the corresponding linear program) and E is the sum of the lengths of the constraint set, which is equal to

(3*Size(D)−1+Size(Z))*(Size(D)+f(n)), where f(n) is a polynomial in n of degree 3.

C. Generalization of the Strategies to the Two Dimensional Case

For the 2 literal case, the set of all clauses is: {T₁, T₂, T₁ [symbol] T₂, T₁ [symbol] [symbol] T₂, [symbol] T₁ [symbol] T₂, [symbol] T₁ [symbol] [symbol] T₂, T₁ [symbol] T₂, T₁ [symbol] [symbol] T₂, [symbol] T₁ [symbol] T₂, [symbol] T₁ [symbol] [symbol] T₂}. This set can be reduced in half, first by removing complementary clauses ( [symbol] ψ is a complementary clause for ψ) and counterpart clauses (a [symbol] [symbol] b is a counterpart of [symbol] a [symbol] b). Thus the set is reduced to: {T₁, T₂, T₁ [symbol] T₂, T₁ [symbol] [symbol] T₂, [symbol] T₁ [symbol] T₂, T₁ [symbol] T_{2}.}

The probabilistic reasoning method discussed above only handles the one dimensional case, where each atom Tᵢ denotes test number i. In the two dimensional case, each test is denoted by Tᵢⱼ, representing test number i executed on node (host) number j. Assume that there are N nodes in the network. Let P(host ⱼ) denote the probability of selection for node number j. Each atom Tᵢ in the equalities/inequalities generated by the above three strategies will now be replaced by Tᵢⱼ.

Thus for strategy BASIC the generalized linear equalities generated are:

1) For each disjunctive clause ψ=T₁ⱼ [symbol] . . . [symbol] Tₘⱼ (m>1, j=1, . . . , N) such that D contains ψ, each non-conjunctive descendant of ψ, and T₁ⱼ [symbol] . . . [symbol] Tₘⱼ, the following linear equality is generated:

P(ψ)=Σ{P(φ)|φ is a child of ψ}−Σ{P(φ)|φ is a grandchild of ψ}+ . . . +(−1)^{m+1} P(T₁ⱼ [symbol] . . . z,900 Tₘⱼ)

At most N such linear equalities will be generated, one for each node in the network.

2) For each conjunctive clause ψ=T₁ⱼ [symbol] . . . [symbol] Tₘⱼ (m>1, j=1, . . . , N) such that D contains ψ, each non-disjunctive ancestor of ψ, and T₁ⱼ [symbol] . . . [symbol] Tₘⱼ, the following linear equality is generated:

$$P ( {T}_{1 j} ⋁ … ⋁ {T}_{mj} ) = {\sum }_{i = 1}^{m} P ( {T}_{ij} ) - \sum \{ P ( ϕ ) \vert ϕ$$

is a non-disjunctive ancestor of ψ}+ . . . +(−1)^{m+1}P(T₁ⱼ [symbol] . . . [symbol] Tₘⱼ).

Again as for case 1, at most N such linear equalities will be generated, one for each node in the network.

3) For each non-disjunctive clause ψ=T₁ⱼ [symbol] . . . [symbol] Tₘⱼ, (m>1, j=1, . . . , N) and its compatible children φ and φ in D, the following linear equality is generated:

P(ψ)=P(φ)+P(φ′)

Strategy INEQS extends the BASIC strategy in the sense that if some descendant of a clause is missing from the control set, then instead of discarding the linear equality altogether, a linear inequality is generated. For a disjunctive clause ψ=T₁ⱼ [symbol] . . . [symbol] Tₘⱼ (m>1,j=1, . . . ,N) such that D contains ψ, and some of ψ's descendants, a ≧ inequality is generated if the probability of the missing descendant(s) was to be added if it was in the control set D. Otherwise, a ≦ inequality is generated. For atomic and conjunctive clauses a ≧ inequality is generated if a child is missing.

EXPSN is the most sophisticated of the three strategies, because it expands missing clauses whenever possible. Again it is based on the BASIC strategy, but if some descendant ψᵢ (direct or not) of a clause ψ is missing, it tries to replace it by its expansion, meaning, it tries to generate the linear equality corresponding to the ψᵢ and replace ψᵢ by its expansion in the original linear equality that is being constructed. The expansion procedure is recursive in the sense that if one or more of ψᵢ's descendants are missing, then EXPSN tries to expand these clauses too. If a clause cannot be expanded (because some of its descendants are missing, and cannot be expanded), then the linear equality is not generated. An important restriction on EXPSN is that, when trying to expand a disjunctive clause of size m, and its conjunctive descendant ψₘ of size m is missing, EXPSN does not try to expand ψₘ as this would result in an infinite loop.

In all three strategies the basic constraints between probabilities of clauses have to hold. For a network of two nodes and two tests these constraints are:

P(T₁₁ [symbol] T₂₁)≧{P(T₁₁),P(T₂₁)}, P(T₁₁)≧P(T₁₁ [symbol] T₂₁), P(T₂₁)≧P(T₁₁ [symbol] T₂₁),

P(T₁₂ [symbol] T₂₂)≧{P(T₁₂),P(T₂₂)} P(T₂₂)≧P(T₁₂ [symbol] T₂₂),P(T₁₂)≧P(T₁₂ [symbol] T₂₂).

To find out the probabilities of the individual and combination tests throughout the whole network independent of the hosts, the following equalities are used:

$$P ( {T}_{i} ) = {\sum }_{j = 1}^{N} P ( {T}_{ij} ) \cdot P ( {host}_{j} ) \qquad \text{(2.3.1)}$$

where Tᵢ is an atomic clause representing test number i. Equation (2.3.1) gives the probability of test number i being positive throughout the whole network.

For any combination test ψ=T₁ [symbol] . . . [symbol] Tₘ, (m>1),

$$P ( ψ ) = {\sum }_{k = 1}^{N} P ( {T}_{1 k} ⋀ … ⋀ {T}_{mk} ) \cdot P ( {host}_{k} ) \qquad \text{(2.3.2)}$$

for all k=1 . . . N.

And for ψ=T₁ [symbol] . . . [symbol] Tₘ, (m>1),

$$P ( ψ ) = {\sum }_{k = 1}^{N} P ( {T}_{1 k} ⋁ … ⋁ {T}_{mk} ) \cdot P ( {host}_{k} ) \qquad \text{(2.3.3)}$$

for all k=1 . . . N.

The one dimensional case is easily derived from the two dimensional case. In the one dimensional case P(Tᵢⱼ)=P(Tᵢ), P(T₁ₖ [symbol] . . . [symbol] Tₘₖ)=P(T₁ [symbol] . . . [symbol] Tₘ), and P(T₁ₖ [symbol] . . . [symbol] Tₘₖ)=P(T₁ [symbol] . . . [symbol] Tₘ).

Using equation (2.3.1),

$$\begin{matrix}P ( {T}_{i} ) = {\sum }_{j = 1}^{N} P ( {T}_{ij} ) \cdot P ( {host}_{j} ) \\ = {\sum }_{j = 1}^{N} P ( {T}_{i} ) \cdot P ( {host}_{j} ) \\ = P ( {T}_{i} ) {\sum }_{j = 1}^{N} P ( {host}_{j} ) = P ( {T}_{i} ) sin\end{matrix}$$

$$ce {\sum }_{j = 1}^{N} P ( {host}_{j} ) = 1.$$

Using equation (2.3.2),

$$\begin{matrix}P ( {T}_{1} ⋀ … ⋀ {T}_{m} ) = {\sum }_{k = 1}^{N} P ( {T}_{1 k} ⋀ … ⋀ {T}_{mk} ) \cdot P ( {host}_{k} ) \\ = {\sum }_{k = 1}^{N} P ( {T}_{1} ⋀ … ⋀ {T}_{m} ) \cdot P ( {host}_{k} ) \\ = P ( {T}_{1} ⋀ … ⋀ {T}_{m} ) \cdot {\sum }_{k = 1}^{N} P ( {host}_{k} ) \\ = P ( {T}_{1} ⋀ … ⋀ {T}_{m} )\end{matrix}$$

Similarly for the case of disjunctive clauses using equation (2.3.3).

D. Objectives and Assumptions

There exists a large pool of tests to be used for testing a network environment. The available pool of tests is too large to be applied all at once due to bandwidth and resource limitations. So the objective of the scheme is to optimize the selection process of both the tests to be performed and the nodes to be tested, in a way that maximizes the probability of selection.

Tests will be denoted by Tᵢⱼ (an atom), representing test number i executed on node number j. Initially, we assume that the probability that any test Tᵢⱼ is positive is P(Tᵢⱼ) [symbol] [0,1], since no information is available. As testing is done P(Tᵢⱼ) can be estimated as the relative frequency of the positive occurrences of the test among all tests performed. Although we start out with a fixed set of tests, more tests can be added on as they become available.

E. Components of the Scheme

The scheme employs an entity called an Adaptive Assessor (AA) which consists of a Reasoning Agent Generator (RAG) and an Adaptive Probabilistic Reasoning System (APRS). RAG consists of two entities: Agent_Generator and Dispatcher.

RAG is responsible for generating agents equipped with tests and dispatching them to targets in the network. The agents perform the specified tests on the targets and record which tests were positive and which ones were negative. This information is reported back to the Agent_Generator in RAG. Using this information Agent_Generator will decide which targets to test and what tests to perform on these targets the next time around. This is accomplished by constructing a Probabilistic theory Z from the information received from the agents. The probabilistic theory Z is then passed on to APRS which converts it into a linear program, which is then solved. Targets and their corresponding tests are selected from three different groups. The first group consists of the set of tests that came back positive during the previous stage. The maximum probability, P(Tᵢⱼ), is selected, which indicates that test i on node j has the maximum probability among the positive tests. Thus node j will be tested using test number i during the next stage. The second group is the set of new tests that have not been executed yet, selection from this group is done at random. Finally, the last group is the set of negative tests. This selection process ensures that no tests are left out, thus preventing any problems within the network from being undetected. This is crucial, since a negative test may become positive at a later point in time.

F. Advanced Two Dimensional Case

If a vulnerability or an intrusion has been detected at a node in a network, then the likelihood that the neighboring nodes are also vulnerable or have suffered an intrusion is very high. The present invention tests not just the single node that was selected but also all the nodes lying within the neighborhood of that node. This increases the probability of detection and allows for quicker measures to be taken to prevent any possible damage from happening. The present invention defines the neighborhood of a node as a cluster of nodes within which the node is located. All nodes in the same neighborhood must be reachable from each other. This is similar to the first level cluster defined in the scheme of clustering that is used for grouping network nodes into clusters for hierarchical routing, see [17]. In clustering the set of nodes in the network are divided into groups called first level clusters. First level clusters are grouped into second level clusters and so on until the m−1 level clusters are formed. Where cluster number m is the union of all the m−1 clusters and encompasses all the nodes in the network. All nodes in the same first level cluster must be reachable from each other. This concept of clustering is used for hierarchical routing, and results in smaller routing tables. In this context of network testing we are only using the concept of the cluster for grouping the nodes together. We are not requiring any change to existing routing schemes that are currently being used.

Thus the neighborhood of a node is the first level cluster within which the node is located. Thus if a vulnerable node is detected within a first level cluster, then the G most vulnerable nodes within that cluster will be tested. The task of clustering in this context is abstract in the sense that it merely assigns cluster numbers to the network nodes and can be done by the network administrator [18]. Other variations on the neighborhood of a node can also be defined, for example, the neighborhood could be defined as the subset of nodes that are one hop away from that node, or two hops away. The present invention uses the first level cluster as the neighborhood.

Referring now in detail to the drawing in which like reference numerals identify similar or identical elements throughout the drawings.

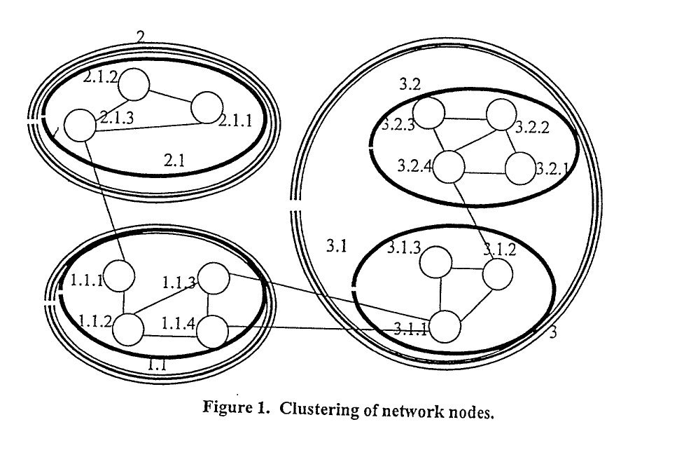

FIG. 1 shows a diagram of a clustering of network nodes, in which a network of 14 nodes that has been divided into neighborhoods or clusters. There are four neighborhoods, namely, clusters 1.1, 2.1, 3.1, 3.2. Thus for example, if node 3.2.3 was selected as a vulnerable node and nodes 3.2.2 and 3.2.1 were the most vulnerable nodes within the neighborhood of node 3.2.3, then the nodes selected for testing, are 3.2.1, 3.2.2, 3.2.3.

The advantages of including the neighborhoods of vulnerable nodes in the selection process is that the total number of nodes selected for testing in each stage increases. If the number of vulnerable nodes selected at each stage is denoted by V then using the advanced two dimensional scheme VG vulnerable nodes are selected during each stage, assuming that the G most vulnerable neighbors are selected, compared to only V vulnerable nodes in the one dimensional scheme.

The present invention enhances [19] the two dimensional case to take into consideration neighborhoods of possible vulnerable nodes rather than just single vulnerable nodes as is done in the original two dimensional case. The main idea is that once a vulnerable node has been identified in the network the algorithm proceeds to select the most vulnerable nodes that are within the neighborhood of the selected vulnerable node.

1). Components of the Advanced Scheme

The advanced two dimensional scheme uses the same components as the original two dimensional scheme, and the same functionality for each component except for RAG.

The present invention defines a function called neighborhood(k) which returns the neighborhood of node k. RAG is modified such that the test and target selection for the set of positive tests is modified to include the neighborhood of vulnerable nodes.

Targets and their corresponding tests are selected from three different groups.

a) The first group consists of the set of tests that came back positive during the previous stage.

Select Tᵢⱼ∪{Tᵢₖ, ∀k=1, . . . , j−1, j+1, . . . , h; nodeₖ [symbol] vul(j)⊂neighborhood(j)} such

that P(Tᵢⱼ) is maximum ∀i, j; i=1, . . . , No_tests; j=1, . . . ,h. vul(j) is the set of the G most vulnerable neighbors of node j

In other words, for every selected Tᵢⱼ such that P(Tᵢⱼ) is maximum, select the G most vulnerable nodes in the neighborhood of node j, where the neighborhood of node j is the set {Tᵢₖ, ∀k=1, . . . , j−1, j+1, . . . , h; nodeₖ [symbol] neighborhood (j)}.

Thus for every selected vulnerable node (node j) the G most vulnerable nodes in the neighborhood of node j are also selected for testing.

b) The second group is the set of new tests that have not been executed yet, selection from this group is done at random.

c) Finally, the last group is the set of negative tests.

This selection process ensures that no tests are left out, thus preventing any problems within the network from being undetected. This is crucial, since a negative test may become positive at a later point in time.

II. The Algorithm

In the initial phase of the algorithm no information is available about the relative frequencies of the assessment tests, in other words, the probability that a particular test Tᵢⱼ is positive is unknown. The only thing we can assume is that it is between 0 and 1, i.e., P(Tᵢⱼ) [symbol] [0,1]. Therefore, RAG simply selects the tests, and hence the targets, at random. Although the selection during this stage is done at random, the number of agents generated and targets selected is kept within the maximum allowable which is determined by the bandwidth and resource limitations imposed.

After the execution of the initial stage the agents report back their findings to RAG. Specifically, each agent will report back which tests were positive indicating the existence of a problem, and which tests were negative. Using this information RAG will now decide which targets to test and retest during the next stage, and which combinations of tests to perform on each target. This is accomplished by formulating a probabilistic theory, which is passed on to APRS, which performs the adaptive reasoning to obtain the probabilities of the positive tests. This information will be passed back to RAG which uses it in deciding the targets to test, and the best combination of tests to perform, for the next stage of execution.

A. The Implementation

The present invention has implemented the one dimensional case [11] and the advanced two dimensional cases [19] to study the performance of the testing scheme.

1). The One Dimensional Case

The present invention begins with the one dimensional case. The following is a detailed description of the algorithm.

Algorithm Vul-Assess-1dim():
Inputs:

/* These values are determined from system constraints, namely, available

bandwidth and computational resources */
A_MAX: maximum number of agents that can be deployed at the same time.
Q: number of stages of testing to perform.

Variables:

T: list of targets selected.
A: list of agents generated.
P-Pos_tests: list of the probabilities of the positive tests.
P-Neg_Tests: list of the probabilities of the negative tests.
New-Tests: a list of tests not performed yet.

Step 1: Initial step

T = Select-Target(random);
A = Agent-Generator(T, random);
Dispatch-Agent(A);
Collect-Info();
Estiamte-Prob();
Creat-Prob-Theory();
APRS(); /*adaptive probabilistic reasoning*/
Q=Q−1;

Step2:
Repeat

T = Select-Target(smart); /*selects targets in a smart manner*/
A = Agent-Generator(T , non-random) ;
Dispatch-Agent(A);
Collect-Info();
Estimate-Prob();
/* During a fixed interval, the known probabilities do not change */
If No. agents deployed>=0.5*A_MAX Then
Begin

/*Update Prob-Theory */
Create-Prob-Theory();
APRS();

End
Q=Q−1;

| | |
|---|---|
| Until Q <= 0 | /* repeat the above steps Q times */ |

end(Vul-Assess-1dim).

The algorithm uses several procedures that are briefly described below.

Select-Target(method) is a procedure that selects the targets to be tested according to method. If method is random, then the targets are selected at random. If method is smart, then the targets will be selected from three distinct groups. The group of hosts that tested positive during the previous stage, the group of hosts that tested negative, and finally the group of hosts that have not been tested yet.

Dispatch-Agent() is a procedure that sends an agent, that has been created by Agent-Generator to test the selected target(s). The agent performs the selected tests on the target(s) to which it was dispatched. The actual testing was simulated by generating a random number between 0 and 1. If the generated number is less than or equal to 0.5 then the test result is positive, otherwise the result is negative. Another distribution was tried, where the probability of a test being positive was 90%, and the probability of being negative was 10%. The results obtained using this distribution were the same as for the previous distribution. So the first distribution was used for deciding whether a test result is positive or negative.

The collect() procedure collects information from the agents. Specifically, for every test performed, it records whether it was positive or negative.

The Estimate-Prob() procedure, computes the relative frequencies of the tests and combinations of tests performed.

Create-Prob-Theory() simply creates a list of the probabilities of the tests and test combinations that are known thus far.

A detailed description of Generate-Agent() is as follows.

Procedure Generate-Agent(T , method)
/* For each target in T, it selects a list of tests according to method. If method is

random, then the tests are selected at random. If method is non-random, then the tests are
selected according to their probabilities. After selection process is done, create agents to
carry out these tests.*/

Begin /* Agent-Generator */
If (method = ‘random’) Then
Begin

Select-tests(random);

End
If (method = ‘non-random’) Then
Begin

Repeat

/* for each target in T create a list of tests*/
For each target in T find the following:
Begin

Maximum {P-Pos-Tests); /* positive test with maximum

probability*/

Maximum(P-Neg-Tests); /* negative test with maximum

probability */

Select-random(New-Tests); /* select at random from the set of tests

never done before */

End

Until all targets in T have been considered.

End
End. /* Agent-Generator */

To describe the algorithm we will first start with a simple example. Assume an agent was dispatched to test a specific target. The agent had four tests to perform, namely, T₁, T₂, T₃, T₄. Assume that T₁, T₂, and T₃ came back positive while T₄ was negative, and assume the following values for the probabilities were known at that time: P(T₁)=0.42, P(T₂)=0.35, P(T₃)=0.4, P(T₅)=0.55, P(T₆)=0.38, P(T₁∩T₂)=0.3, where T₅ and T₆ are two new tests, not executed before on this target.

At this point RAG constructs a probabilistic theory, which is basically a list of the available probabilities. For this example, the probabilistic theory is the following:

| | |
|---|---|
| P(T₁) = 0.42 | P(T₅) = 0.55 |
| P(T₂) = 0.35 | P(T₆) = 0.38 |
| P(T₃) = 0.4 | P(T₁ ∩ T₂) = 0.3 |

Notice that P(T₄) and P(T₁∩T₃) and P(T₂ ∩T₃) are not known and are initially estimated as [0,1], this means that T₄ ,i.e. test 4, has not tested positive before this, or has come back positive but the updating of the probabilities has not been done yet. Similarly for the other two. At this point RAG passes on the probabilistic theory to APRS, which performs probabilistic reasoning to obtain the unknown probabilities. The following are the results obtained:

P(T₁∩T₃)=[0,0.4], P(T₂∩T₃)=[0,0.35], P(T₄) [symbol] [0,1].

RAG will now have to decide the best combination of tests to perform on the particular target the next time around. This is accomplished by finding out the following:

a) The maximum of {P(T₁), P(T₂), P(T₃)} which is P(T₁)=0.42.

b) Select at random from the set of new tests, in this example T₅ and T₆ are two new tests that have not been executed. A random number generator is used to generate a random number between 0 and M (total number of tests available). This random number is used to choose between T₅ and T₆. Assume that T₅ is chosen.

c) The maximum of the probabilities of all the negative tests, in this case P(T₄).

According to the above calculations the combination of tests for the next stage will consist of the following: T₁, T₄, T₅.

B. The Advanced Two Dimensional Case

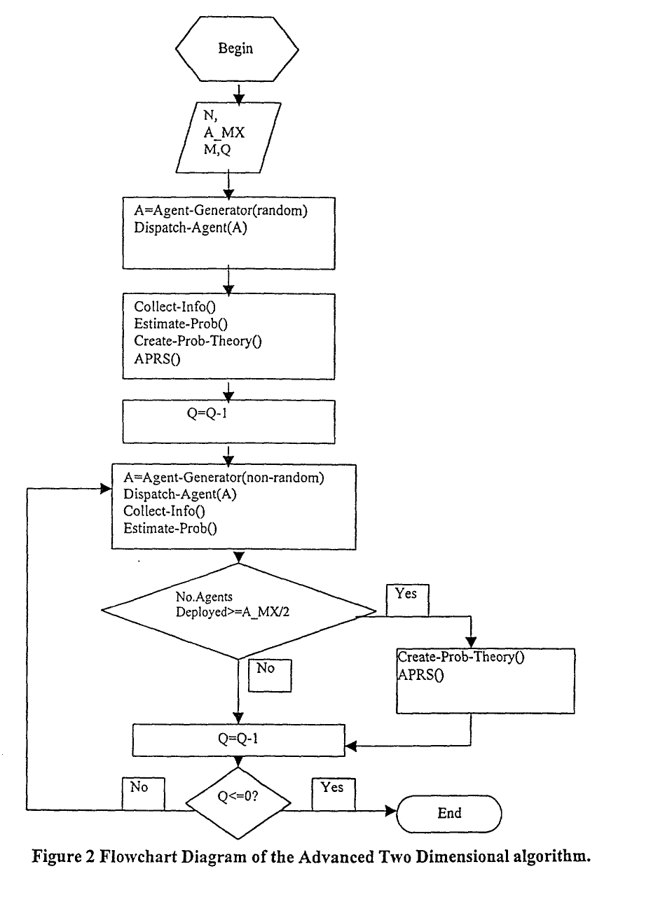

FIG. 2 shows a flowchart diagram of the algorithm. The algorithm executes Q stages, however, in the actual implementation of the algorithm the execution continues until a steady state is reached, see section 5 for a description of the steady state.

Algorithm Vul-Assess-2dim():
Inputs:

/* These values are determined from system constraints, namely, available

bandwidth and computational resources */

A_MX: maximum number of agents that can be deployed at the same time.
Q: number of stages of testing to perform.

Variables:

A: list of agents generated. An agent consists of a list of tests to perform,

and the target on which to perform the tests on.

/* The following 3 arrays, are 2 dimensional arrays, where the row index

specifies the test number, and the column index specifies the target (host).

P-Pos_tests: list of the probabilities of the positive tests for the whole

network.

P-Neg_Tests: list of the probabilities of the negative tests for the whole

network.

New-Tests: a list of tests not performed yet for the whole network.

Step 1: Initial step

A = Agent-Generator(random);
Dispatch-Agent(A);
Collect-Info();
Estiamte-Prob();
Creat-Prob-Theory();
APRS(); /*probabilistic reasoning*/
Q=Q−1;

Step2:
Repeat

A = Agent-Generator(non-random);
Dispatch-Agent(A);
Collect-Info();
Estimate-Prob();
/* During a fixed interval, the known probabilities do not change */
If No. agents deployed>=0.5*A_MAX Then
Begin

/*Update Prob-Theory */

Create-Prob-Theory();
APRS();

End
Q=Q-1;

| | |
|---|---|
| Until Q <= 0 | /* repeat the above steps Q times */ |
| end(Vul-Assess-2dim). | |

The algorithm uses several procedures that are briefly described below.

Dispatch-Agent() is a procedure that sends an agent, that has been created by Agent-Generator to test the selected target(s). The agent performs the selected tests on the target(s) to which it was dispatched. The actual testing was simulated by generating a random number between 0 and 1. If the generated number is less than or equal to 0.5 then the test result is positive, otherwise the result is negative.

The collect() procedure collects information from the agents. Specifically, for every test performed, it records whether it was positive or negative.

The Estimate-Prob() procedure, computes the relative frequencies of the tests and combinations of tests performed. Where the relative frequency of a test Tᵢⱼ is defined as, P(Tᵢⱼ)=(No. positive occurrences of Tᵢⱼ) /Total No. tests.

Create-Prob-Theory() simply creates a list of the probabilities of the tests and test combinations that are known thus far.

This procedure selects from three groups of tests. The first group, P-Pos-Tests, is a 2 dimensional array, where the row index denotes the test number, and the column index denotes the target. This array specifies the probabilities of all positive tests throughout the whole network (i.e. for all the nodes (targets)). Each element specifies the probability of positive test i on host j, T_{i j}, for all i<=maximum number of tests, and for all j<=the number of nodes.

The second group, P-Neg-Tests, is the same as P-Pos-Tests, except it is an array of the probabilities of the negative tests, similarly, New-Tests, is an array of the probabilities of the tests never done before,

Procedure Agent-Generator(method)
/* Selects tests and targets according to method. If method is random, then the
selection is done at random. If method is non-random, then the tests are selected

according to their probabilities. */

Begin /* Agent-Generator */
If (method = ‘random’) Then
Begin

Select-tests(random);

End
If (method = ‘non-random’) Then
Begin

PT=Maximum(P-Pos-Tests); /* positive test with maximum

probability*/

Vul(Neighborhood(PT),G); /*Select from neighborhood of

PT*/

Maximum(P-Neg-Tests); /* negative test with maximum

probability */

Select-random(New-Tests); /* select at random from the set of tests

never done before */

End
End./* Agent-Generator */

So this procedure selects a set of tests, where each test Tᵢⱼ selected, denotes test number i to be performed on host (node) j.

To describe the algorithm we will first start with a simple example. Assume a 7 node network, and two tests to be performed on the network. Let Tᵢⱼ denote test number i on node j. Assume that the following tests came back positive from the previous stage of execution: T₁₁, T₂₁, T₂₂, T₁₇, T₂₆, T₂₅, T₁₅, and that the negative tests were: T₁₂, T₂₃, T₁₃, T₂₄, and tests T₁₄, T₁₆, T₂₇ have never been performed. Assume the following probabilities are known at this point:

P(T₁₁)=0.42, P(T₂₁)=0.35, P(T₁₃)=0.4, P(T₂₃)=0.5, P(T₁₂)=0.37, P(T₂₃)=0.7, P(T₁₄)=0.4, P(T₂₂)=0.65, P(T₁₇)=0.19, P(T₂₅)=0.7, P(T₂₆)=0.48, P(T₁₁∩T₂₁)=0.3, P(T₂₃∩T₁₃)=0.4, P(T₁₅)=05.

Using these values RAG (i.e. Agent-Generator) creates a probabilistic theory that is passed on to APRS which performs probabilistic reasoning to obtain the unknown probabilities. The following are the results obtained: P(T₁₅∩T₂₅)=[0,0.5].

RAG will now decide the targets to be tested and what tests to be performed on these targets. This is accomplished by finding out the following:

1). Maximum of {P(T₁₁), P(T₂₁), P(T₂₂), P(T₁₇), P(T₂₆), P(T₂₅), P(T₁₅)} which is P(T₂₅)=0.7. Now the most vulnerable nodes in the neighborhood of node 5 are also selected. The neighborhood of node 5 consists of two nodes, namely, nodes 6 and 4, and node 6 is the most vulnerable. Thus at this point two nodes have been selected: nodes 5,6

2). Maximum of negative tests which is P(T₂₃)=0.5.

3). Select at random from the set of new tests, assume T₂₇ is selected.

According to these calculations nodes 5,6 are to be tested using test number 2, and nodes 3 and 7 are to be tested using test number 2.

III. Probabilities of the Tests

As mentioned above, initially, the probability of any test Tᵢ being positive is unknown and is assumed to be P(Tᵢ) [symbol] [0,1] . As testing is performed and new values for the probability estimates are obtained, we may end up with single valued probabilities and interval-valued probabilities. So the question is, how do we choose the maximum of these values as is required in the procedure Generate-Agent(). If all the probabilities are single-valued, then it is simply straightforward, just find the maximum value of these probabilities. If the probabilities are all interval-valued, then to find the maximum we have to consider three cases. This is illustrated by way of an example. Assume that we have two intervals, [a, b] and [c, d].

Case 1: if interval [a,b] is a subset of interval [c,d], i.e. a>=c, b<=d then choose the tightest interval as the maximum, namely, [a,b].

Case 2: if interval [a,b] is not a subset of interval [c,d], then choose the maximum as the interval with the largest values for its bounds. Namely, if a>c, and a>d, and b>d , then the maximum is the interval [a,b], otherwise, the maximum is [c,d].

Case 3: if intervals [a,b] and [c,d] are overlapping, i.e. a<c<b and b<d, then the maximum is [c,d].

In the mixed case, there are both single-valued probabilities and interval-valued probabilities, the single-valued probabilities is treated as an interval with the same upper and lower bound, namely, [a, a], and apply the above cases.

IV. Results

A. For the One Dimensional Case

The algorithm is tested based on the assumption that a network of 10 nodes to be tested using 30 different tests. The present invention defines the steady state of the algorithm as the state when the probabilities of the tests are stable. A test is stable if the probability of the test from the previous stage and the probability at the current stage are within epsilon of each other. In other words Pₖ(Tᵢ)−Pₖ₋₁(Tᵢ)≦ [symbol] . The probability of miss (not selecting) for nodes was used as a measure of the algorithms' performance. Other measures were also used to study the performance of the algorithm. The ratio of the probability of node selection to the vulnerability of the node. Where probability of node selection was measured as the number of times the node was selected to the total number of node selections done. Node vulnerability is a measure of whether a node suffers from the problem that we are currently testing for using the pool of tests available, and it is measured as the ratio of the total number of positive tests for the node, to the total number of positive tests executed in the network. Another measure of performance was the ratio of the probability of selection for the tests to the probability of a test being positive.

The probability of miss is the probability of failing to select a vulnerable node, and is defined by the following formula: Prob(miss)=1−Prob(Selection|Vulnerable), where Prob(selection|vulnerable) is the probability of selecting a node given that it is vulnerable. In the cases, where no vulnerabilities exist, and when the number of selected nodes (max_h) is equal to the total number of nodes (h) to be tested, the Prob(miss) should be 0. In the case of random selection of the nodes with no regard to the vulnerability of the nodes in the selection process, the probability of miss is given by

$$1 - \frac{max \_ h}{h} .$$

For our method of selection, we define the probability of miss by the following formula:

$$1 - \frac{1}{q} {\sum }_{k = 1}^{q} {P}_{k} ( host ( j ) \vert Pos ( j ) is maximum ∀ i = 0 , … , No\_tests , \\ ∀ j = 0 , … , h ) ,$$

, where q is the number of stages executed, h is the number of nodes to be tested, max_h is the number of nodes selected for testing at each stage, Pₖ (host(j)) is the probability of selection for node j at stage k, Pos(j) is the number of positive tests at node j, and No_tests is the total number of tests to be performed. The probability of miss for different values of max_h is shown in table 1.

TABLE 1
Probability of miss

| Max_h | Prob(miss) |
|---|---|
| 4 | 0.36 |
| 6 | 0.24 |
| 9 | 0.21 |

These values were obtained under steady state conditions. It is apparent that increasing the number of nodes tested simultaneously (max_h) decreases the probability of miss.

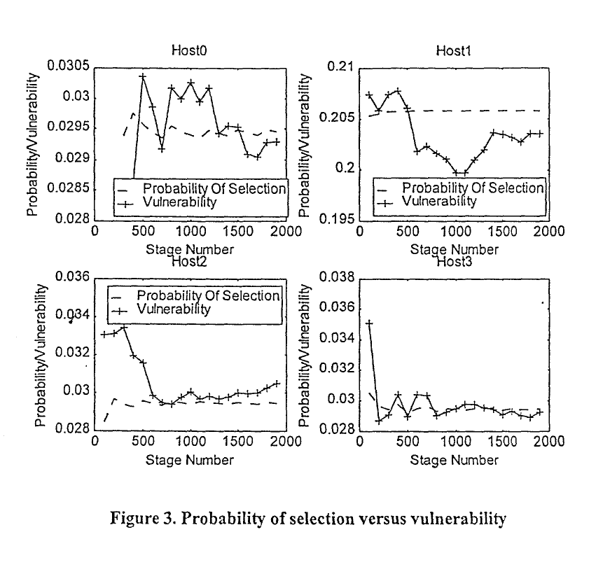

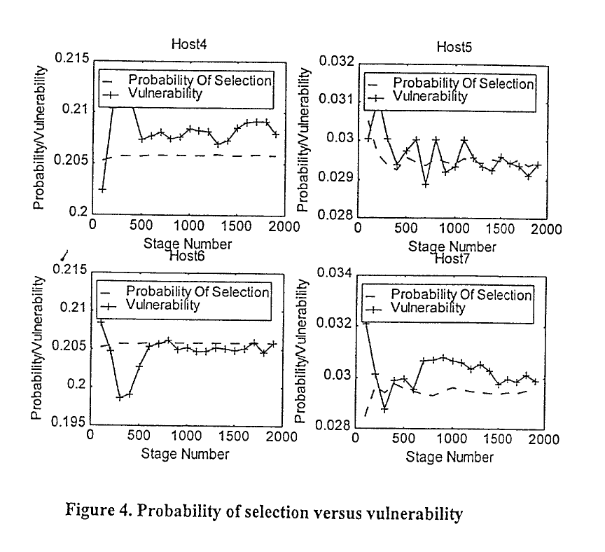

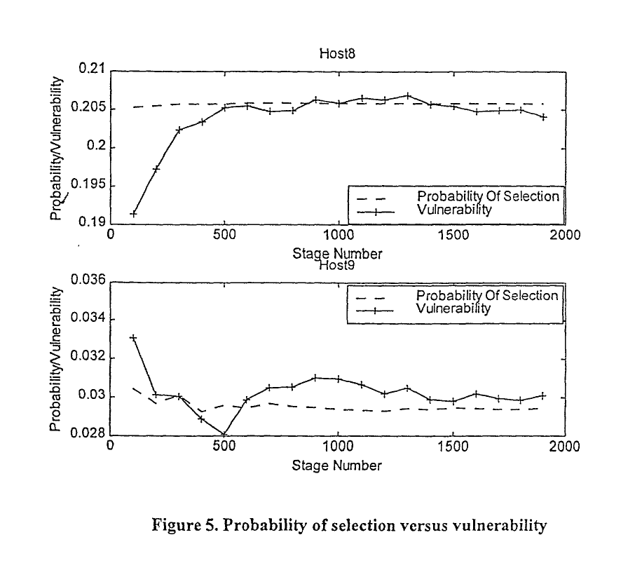

FIGS. 3,4,5 show the plot of the probability of selection versus the vulnerability. FIG. 3. shows the plot of the probability of selection versus vulnerability for nodes 0,1,2, and 3. It is apparent from the plot that the ratio of the probability of selection and vulnerability converges to 1.00 at the steady state. This is expected since the vulnerability of a node determines it's probability of selection, in other words the more vulnerable the node is the more likely it will be selected. The same is true for the other nodes, see FIGS. 4 and 5.

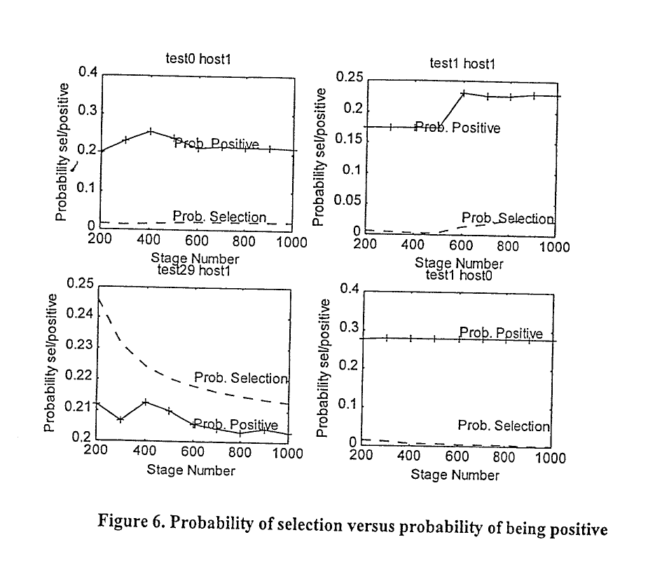

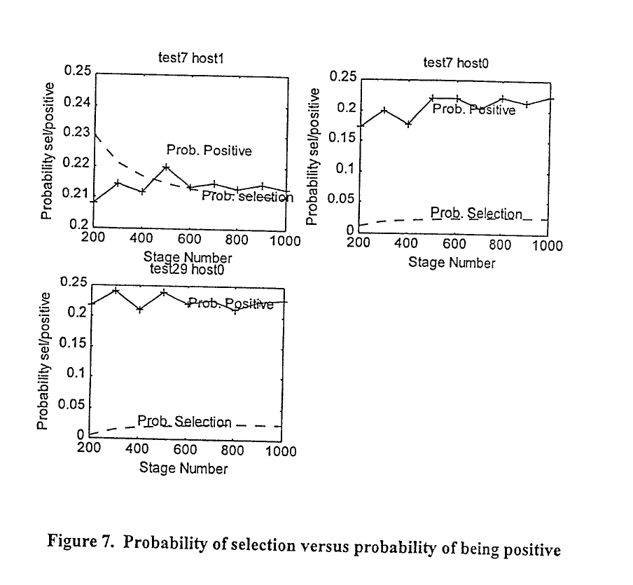

FIGS. 6 and 7 show the plot of the probability of selection versus the probability of being positive for a set of tests for nodes 0 and 1. Comparing the ratio of the probability of selection and the probability of being positive for nodes 0 and 1, it is apparent that for node 1, which is much more vulnerable than node 0, the ratio for tests7 and 29 is almost 1.0, whereas for node 0 the ratio is around 0.1. As for test 1 the ratio is less than 0.1 for both nodes 0 and 1, which is an indication that test 1 is infrequently selected for testing on both nodes.

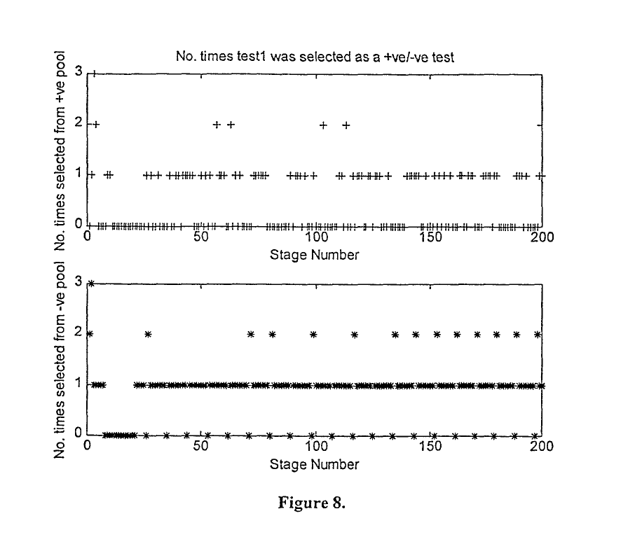

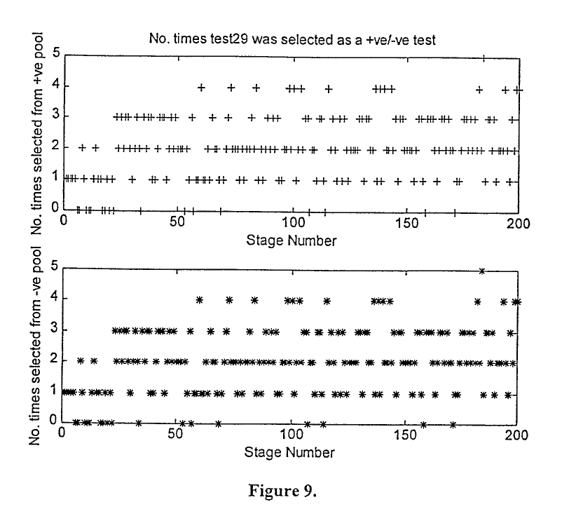

FIG. 8 is a plot of the number of times test1 was selected as a negative test and the number of times it was selected as a positive test for all the nodes. It is apparent that test1 is not selected as frequently as test29, see FIG. 9. In FIG. 9 the same plot for test 29 is shown.

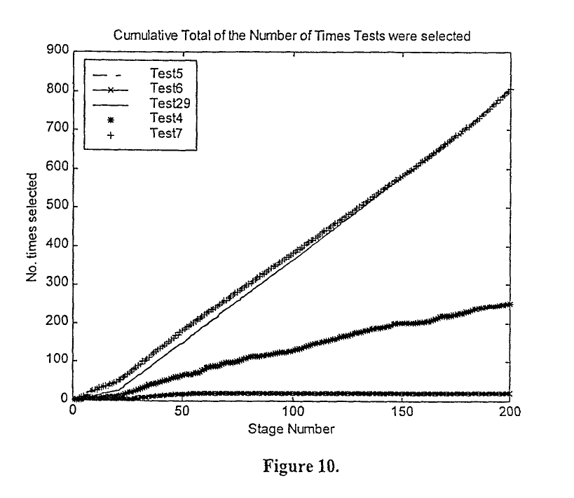

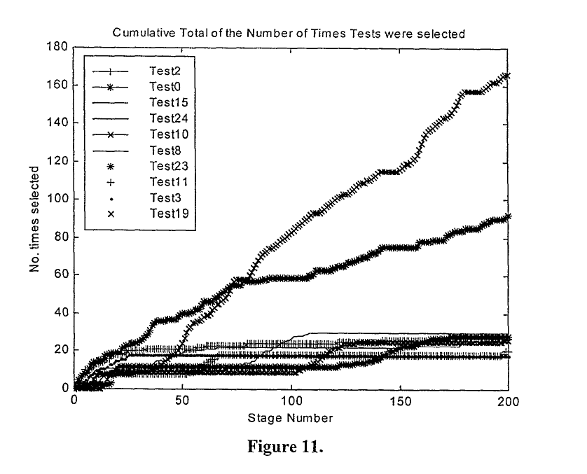

FIGS. 10 and 11 are plots of the cumulative total of the number of times a set of tests were selected within 200 stages of execution of the algorithm. Tests 7 and 29 are the most selected tests, up to almost 800 times within the 200 stages. Test 4 is selected up to 250 times, which is then followed by tests 24 and 10, they are selected up to 166 times. The rest of the test set falls between 90 and 24 times.

B. The Advanced Two Dimensional Case

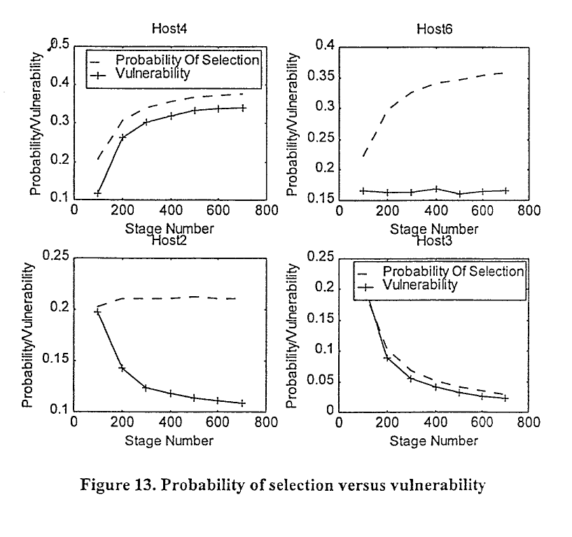

For the advanced two dimensional case we assumed a network of 10 nodes. The present invention defines the neighborhood of a node to be the first level cluster of nodes, which is the set of nodes that are reachable from each other. The average neighborhood size is 3 nodes. The present invention defines the steady state of the algorithm as the state when the probabilities of the tests are stable. A test is stable if the probability of the test from the previous stage and the probability at the current stage are within epsilon of each other. In other words Pₖ(Tᵢⱼ)−Pₖ₋₁(Tᵢⱼ)≦ [symbol] . The present invention computes the probability of selection for the nodes and compared it to the node vulnerability. The results are depicted in FIGS. 13,14,15. For each node the plot of the probability of selection and the vulnerability is made. The most vulnerable node is node 4, and it has the highest probability of selection among the 10 nodes in the network. FIG. 13 shows the plots for node 4 and its neighbors. For node 4 the ratio of the probability of selection and the vulnerability converges to 1.00 at the steady state. For the two most vulnerable neighbors selected, namely, nodes 6 and 2, the ratio converges to 2.00. This results from the fact that whenever node 4 is selected, these two most vulnerable nodes are also selected, so their probability of selection is related to the probability of selection of node 4. As for node 3 the non-vulnerable neighbor, the ratio converges to 1.00 at stability.

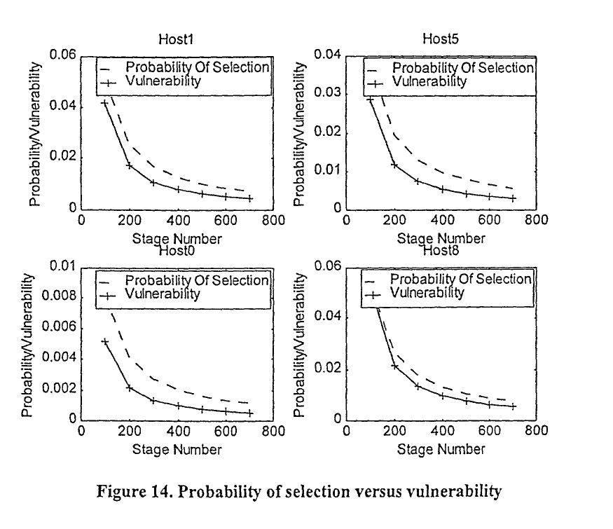

FIG. 14 shows the plots of the probability of selection and vulnerability for nodes 1,5,0,8. Node 8 is one of the vulnerable nodes in the network, and the ratio of the probability of selection to the vulnerability for this node also converges to 1.00 at the steady state. As for the two most vulnerable neighbors of node 8,namely, nodes 1 and 5, the ratio converges to 1.8 at the steady state. Again this results from the fact that the selection of nodes 1 and 5 is related to the selection of node 8. Every time node 8 is selected these two nodes are also selected, since they are the two most vulnerable neighbors of node 8.

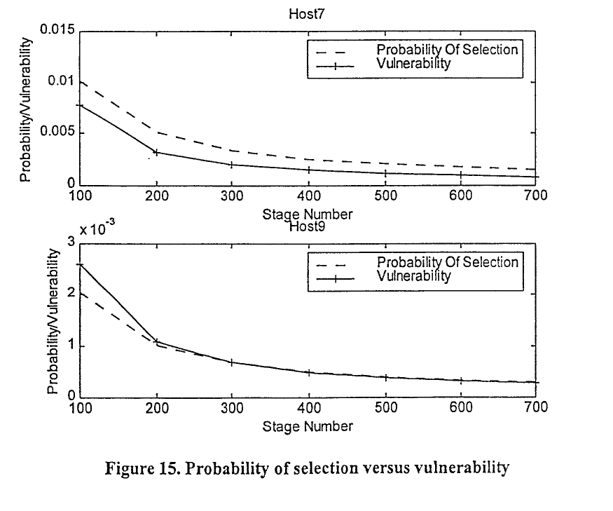

Finally FIG. 15. shows the plot of the probability of selection and vulnerability for nodes 7 and 9. These two nodes are non vulnerable nodes within the network. The ratio of the probability of selection to the vulnerability converges to 1.8 for node 7 and 1.1 for node 9 at steady state.

The probability of miss for the advanced two dimensional case is defined by the following formula:

$$1 - \frac{1}{q} {\sum }_{k = 1}^{q} \{ [ {P}_{k} ( host ( j ) \vert P ( Tij ) is maximum ∀ i = 0 , … , No\_test , ∀ j = 0 , … , h ) ] + \sum [ {P}_{k} ( host ( w ) \vert P ( {T}_{iw} ) is maximum , w ∈ vul ( j ) ⋐ neighborhood ( j ) ) \}$$

where q is the number of stages executed, h is the number of nodes to be tested, max_h is the number of nodes selected for testing at each stage, Pₖ(host(j)) is the probability of selection for node j at stage k, P(Tᵢⱼ) is the probability of test i being positive at node j, No_tests is the total number of tests to be performed, and neighborhood(j) is the set of nodes in the neighborhood of node j as defined above. vul(j) is a set of size G of the most vulnerable nodes in the neighborhood of node j. Thus for every vulnerable node j selected, the G most vulnerable neighbors are also selected.

Table 2 shows the probability of miss for different values of max_h.

TABLE 2
Probability of miss

| Max_h | Prob(miss) |
|---|---|
| 4 | 0.112 |
| 6 | 0.09 |
| 8 | 0.0 |

Increasing the number of nodes tested simultaneously (max_h), decreases the probability of miss. In fact from the results in table 2, only testing 6 nodes simultaneously gives a probability of miss of 0.09, which is quite good compared to the method of random selection were the probability of miss is 0.4.

C. Comparison of the One Dimensional and Advanced Two Dimensional Cases

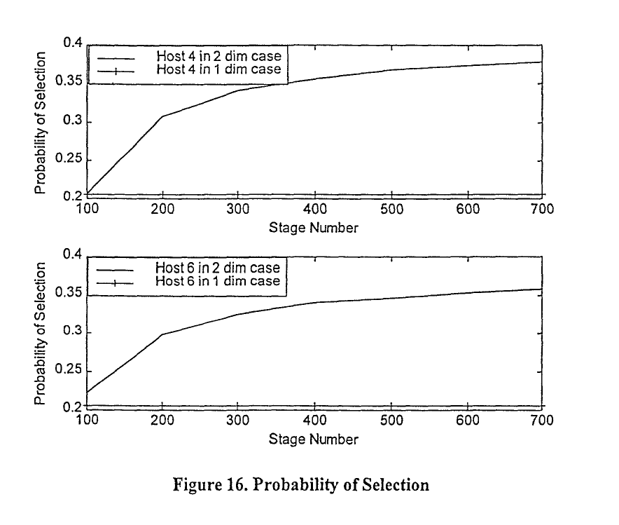

The present invention compares the one dimensional and the advanced two dimensional cases with respect to the probability of selection and the probability of miss. FIG. 16 shows the plot of the probability of selection for the two most vulnerable nodes in the network, namely, nodes 4 and 6.

The advanced two dimensional case reaches the stable state after 700 stages of execution, compared to 1900 stages for the one dimensional case. For the most vulnerable node, node 4, the probability of selection in the two dimensional case is 1.84 times larger than the probability of selection for the same node in the one dimensional case. For node 6 the probability of selection in the two dimensional case is 1.7 times larger than in the one dimensional case. Thus the two dimensional case increases the probability of selection of the vulnerable nodes in the network. This in turn results in a lower probability of miss. This comes from the fact that for every vulnerable node selected, the G most vulnerable neighbors of that node are also selected for testing. This is apparent in the formula for the probability of miss.

Probability of miss for the two dimensional case:

$$1 - \frac{1}{q} {\sum }_{k = 1}^{q} \{ [ {P}_{k} ( host ( j ) \vert P ( {T}_{ij} ) is maximum ∀ i = 0 , … , No\_tests , ∀ j = 0 , … , h ) ]$$

+Σ[Pₖ(host(w)|P(T_{iw})is maximum, w [symbol] vul(j)⊂neighborhood(j))}

Probability of miss for the one dimensional case:

$$1 - \frac{1}{q} {\sum }_{k = 1}^{q} {P}_{k} ( host ( j ) \vert Pos ( j ) is maximum ∀ i = 0 , … , No\_tests , ∀ j = 0 , … , h )$$

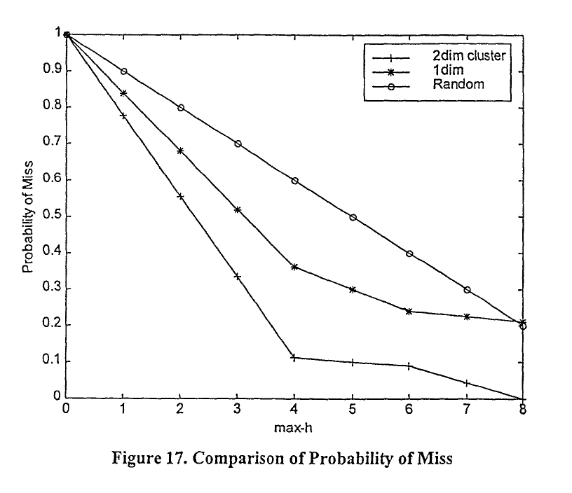

The probability of miss for the one dimensional, advanced two dimensional and random cases are shown in FIG. 17. In the random case nodes are selected at random with no regard to their vulnerability. These values are computed for h=10 nodes. In all three cases increasing the number of nodes tested simultaneously, namely, max-h, decreases the probability of miss. Both the one and two dimensional cases give better results than the random case of node selection. However, the two dimensional case gives better results for the probability of miss than the one dimensional case. In choosing between testing schemes, the scheme that provides the smallest probability of miss should be chosen. In section 5.1 we stated that in the case of a random selection scheme, where no consideration is taken into the vulnerability of the nodes in the selection process, the best value for the probability of miss we can expect is

$$1 - \frac{max\_ h}{h} ,$$

this provides us with an upper bound for the probability of miss for our testing scheme.

The tradeoff between the one dimensional and advanced two dimensional schemes, is that although in the two dimensional scheme we are increasing the number of nodes tested simultaneously, we are actually saving both bandwidth and computing resources since one agent is assigned for testing a cluster of nodes within a neighborhood as opposed to dispatching 1+G agents; one agent for testing the selected vulnerable node, and the G agents for testing the G most vulnerable neighbors of the selected node. Increasing the number of nodes tested simultaneously also decreases the probability of miss compared to the one dimensional scheme.

In a brute force testing scheme where all the tests are applied to all the nodes simultaneously, the number of tests applied per stage would be No_tests*h, which for our example is 300 tests per stage. Because of the bandwidth and resource limitations imposed, this scheme is not feasible. In our advanced two dimensional scheme, the number of tests executed during each stage is

$$\frac{max\_ h}{2} ( 2 + G ) ,$$

where max_h is the number of nodes to be tested simultaneously, G is the number of vulnerable neighbors selected for each vulnerable node. Here we are assuming that

$$\frac{max\_ h}{2}$$

vulnerable nodes are selected, and the remaining

$$\frac{max\_ h}{2}$$

are selected from the negative, and new nodes. If the number of vulnerable nodes in the network is V, V<=h, then the advanced two dimensional scheme would select the

$$\frac{max\_ h}{2}$$

most vulnerable nodes of these V nodes together with their most vulnerable neighbors. For a 10 node network (h=10) with G=2, and max_h=8, the number of nodes/tests applied per stage would be 16 in the two dimensional scheme, compared to 300 in the brute force scheme, and assuming that the number of vulnerable nodes is V=4, then the two dimensional scheme selects these four nodes in addition to their most vulnerable neighbors, which is indicated by the fact that the probability of miss for this case is 0. Thus the two dimensional scheme is able to test these vulnerable nodes using only 5% of the available test pool.

Having described preferred embodiments of a probabilistic reasoning mobile agent system for testing telecommunication networks (which are intended to be illustrative and not limiting), it is noted that modifications and variations can be made by persons skilled in the art in light of the above teachings. It is therefore to be understood that changes may be make in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

### References

[1] Jacobs, S., Dumas, D., Booth, W., Little, M., “Security Architecture for Intelligent Agent Based Vulnerability Analysis”, MILCOM 1999.

[2] Conner, M., Patel, C., Little, M., “Genetic Algorithm/Artificial Life Evolution of Security Vulnerability Agents”, MILCOM 1999.

[3] Barret, M., Little, M., Poylisher, A., Gaughan, M., Tardiff, A., “Intelligent Agents for Vulnerability Assessment of Computer Networks”,Proceedings of the 2^{nd} Annual FedLab Symposium-Advanced Telecommunications & Information Distribution, U.S. Army Research Labs, 1998.

[4] Pearl, J., Probabilistic Reasoning in Intelligent Systems, Morgan Kaufmann, 1986.

[5] Khreisat, Laila., Dalal, M., “Anytime Reasoning with Probabilistic Inequalities”, Proceedings of the Ninth IEEE International Conference on Tools with Artificial Intelligence, Nov., 1997.

[6] Nilsson, N. J., Probabilistic Logic, Artificial Intelligence, 28(1):71-87, 1986.

[7] Fagin, R., Halpern, J. Y., and Megiddo, N., “A Logic for Reasoning about Probabilities”, Information and Control, 87:78-128, 1990.

[8] Mendelson, E., Introduction to Mathematical Logic, Van Nostrand, Princeton, N.J., 1964.

[9] Karmarkar, N., “A New Polynomial-time Algorithm for Linear Programming”, Combinatorica, 4:302-311, 1984.

[10] Pham, V., Karmouch, A., “Mobile Software Agents: An Overview”, IEEE Communications Magazine”, 36(7), July 1998.

[11] Khreisat, L., Saadawi, T., Lee, M., “Anytime Probabilistic Reasoning Mobile Agent System for Network Testing”, ATIRP 2000.

[12] Kumar, S., “Classification and Detection of Computer Intrusions”, Ph.D. Thesis, Purdue University, August 1995.

[13] Rothermel, K., Popescu-Zeletin, Eds., “Mobile Agents”, lecture Notes in Comp. Sci. Series, vol. 1219, Springer 1997.

[14] Crosbie, M., Spafford, G., “Defending a Computer System using Autonomous Agents”, Tech. Report No. 95-022, Dept. Computer Science, Purdue University, 1994.

[15] Crosbie, M., Spafford, G., “Active Defense of a Computer System using Autonomous Agents”, Tech. Report No. 95-008, Dept. Computer Science, Purdue University, 1995.

[16] Mobile Agents White Paper, General Magic, 1997.

[17] Saadawi, T.,Ammar, M.,Hakeem, A., Fundamentals of Telecommunication Networks, John Wiley & Sons,1994.

[18] Schwartz, M., Telecommunication Networks:Protocols, Modeling and Analysis,Addison-Wesly, 1987.

[19] Khreisat, L., Saadawi, T., Myung, L., “Adaptive Probabilistic Reasoning Mobile Agent System for Network Testing: Two dimensional case” submitted to IEEE JSAC 2000.

What is claimed is:

1. A method for testing telecommunication networks using an intelligent mobile agent system, comprising the steps of:
detecting at least one target in a network;
selecting a target to be tested from the at least one target;
providing a mobile agent with a test; and
applying the mobile agent with the test to the selected target for testing.
